(19) United States
(12) Patent Application Publication
(10) Pub. No.: US 2025/0079611 A1
(43) Pub. Date: Mar. 6, 2025

(54) BATTERY PACK MOUNTING STRUCTURE FOR VEHICLE

(71) Applicants: Hyundai Motor Company, Seoul (KR); Kia Corporation, Seoul (KR)

(72) Inventors: Gyung Hoon Shin, Seoul (KR); Jong Gyu Park, Hwaseong-si (KR)

(21) Appl. No.: 18/605,044

(22) Filed: Mar. 14, 2024

(30) Foreign Application Priority Data
Sep. 4, 2023 (KR) 10-2023-0117148

(51) Int. Cl. H01M 50/249; B60K 1/04; B60R 16/033; H01M 50/204; H01M 50/262

(52) U.S. Cl. CPC H01M 50/249; B60R 16/033; H01M 50/204; H01M 50/262; B60K 1/04; H01M 2220/20

(57) ABSTRACT

An embodiment battery pack mounting structure for a vehicle includes a side member disposed at a lateral side of a battery pack, the side member including a plurality of partition walls, a side bush fastened passing through the side member vertically and passing through the plurality of partition walls, and a side mounting bolt fastened to a vehicle body while passing through the side bush and the plurality of partition walls.

### CROSS-REFERENCE TO RELATED APPLICATIONS

This application claims the benefit of Korean Patent Application No. 10-2023-0117148, filed on Sep. 4, 2023, which application is hereby incorporated herein by reference.

### TECHNICAL FIELD

The disclosure relates to a battery pack mounting structure for a vehicle.

### BACKGROUND

An electric vehicle or the like includes an electric motor to generate a driving force for the vehicle and a battery pack to supply electric power to the electric motor.

The battery pack accommodates a plurality of battery modules, and a plurality of battery cells are overlapped to make up the battery module.

To increase the range of the vehicle, the battery pack needs to accommodate more battery modules or battery cells therein. Further, to ensure appropriate crash performance of the vehicle, a plurality of reinforcing members is required in the battery pack.

In other words, when the plurality of reinforcing members is provided in the battery pack to ensure the crash performance of the vehicle, it is disadvantageous to increase the range of the vehicle because the number of battery modules or battery cells accommodated in the battery pack is reduced. On the other hand, when the reinforcing members in the battery pack are decreased to accommodate more battery modules in the battery pack, it is disadvantageous to ensure the crash performance of the vehicle because the rigidity of the battery pack is lowered.

Meanwhile, the foregoing battery pack is mounted to a lower side of a vehicle body, in which the side portions of the battery pack are secured to and supported on the lower side of the vehicle body.

The matters described as the related art are merely intended to promote the understanding of the background of embodiments of the disclosure but should not be accepted as recognition of the prior art that has already been known to a person having ordinary knowledge in the art.

### SUMMARY

An embodiment of the disclosure provides a battery pack mounting structure for a vehicle in which, when a battery pack is mounted to a lower side of a vehicle body, the battery pack supported on the vehicle body is structured to more effectively distribute and support an external impact applied to the vehicle, thereby improving the crash performance of the vehicle body and the battery pack.

According to an embodiment of the disclosure, a battery pack mounting structure for a vehicle includes a side member provided at a lateral side of a battery pack, a side bush fastened passing through the side member vertically, and a side mounting bolt fastened to a vehicle body while passing through the side bush, wherein the side member includes a plurality of partition walls through which the side mounting bolt passes, and the side bush is fastened passing through the plurality of partition walls.

The side bush may be coupled to the side member as an upper unit fastened from above the side member and a lower unit fastened from below the side member are coupled to each other.

The upper unit and the lower unit may be forcibly fitted to each other to be formed as a single body.

Relatively to each other, the upper unit and the lower unit may include a plurality of ribs formed locally protruding from a circumferential surface thereof and a retainer formed to keep the plurality of ribs transformed and inserted therein.

Relatively to each other, the upper unit and the lower unit may include a male threaded portion formed locally protruding from a circumferential surface thereof and a female threaded portion formed to keep the male threaded portion transformed and inserted therein.

At least one of the upper unit and the lower unit may be provided integrally with a stopper protrusion that restricts rotation relative to the side member, and the side member may be formed integrally with a stopper groove that allows the stopper protrusion to be inserted therein and prevents the side bush from the relative rotation.

The side bush may be formed with a plurality of comb-pattern protrusions on an outer circumferential surface thereof so as to be forcibly fitted into the side member.

The side bush may be shaped like a cone of which an outer diameter decreases downwards from a top flange, and the comb-pattern protrusions formed on the outer circumferential surface of the side bush may be press-fitted to all the plurality of partition walls of the side member.

The top flange may be provided on a top of the side bush, and a lower portion of the side bush having a cylindrical shape may be forcibly transformed to enlarge an inner diameter thereof in a state of being coupled to the side member so that the side bush can be integrated into the partition wall of the side member.

The plurality of partition walls of the side member may be formed in parallel with each other, and the side bush may be coupled penetrating the plurality of partition walls perpendicularly.

The side members, together with a frontward wall and a rearward wall, may form an accommodating space to accommodate the plurality of battery modules, a longitudinal member may cross the accommodating space and includes both ends supported on the frontward wall and the rearward wall, and a transverse member may intersect the longitudinal member and includes both ends supported on the opposite side members.

Only one longitudinal member and only one transverse member may be provided in the accommodating space.

The side member may be provided with a module mounting bar on an inner side thereof, and the battery module accommodated in the accommodating space may have a structure in which one of two sides perpendicular to an overlapping direction of battery cells is fastened to the module mounting bar and the other is fastened to the longitudinal member.

A center mounting bolt for securing the battery pack to the vehicle body by penetrating the battery pack vertically may be fastened at an intersection between the longitudinal member and the transverse member.

At the intersection between the longitudinal member and the transverse member, a through mounting bush may be provided penetrating the battery pack from a lower side of the battery pack to an upper side of the transverse member in order to form a space through which the center mounting bolt passes, a securing mounting bush may be inserted in the upper side of the transverse member to surround an outer side of the through mounting bush, and a bush bolt may be coupled to a top of the through mounting bush while forming a space for the center mounting bolt to pass therethrough and including a top for pressing the securing mounting bush against the transverse member.

According to another embodiment of the disclosure, a battery pack mounting structure for a vehicle includes a side member including a horizontal extension portion protruding in a lateral direction and a side bush fastened penetrating the horizontal extension portion of the side member vertically, wherein the horizontal extension portion of the side member includes a plurality of horizontal plates spaced apart from each other vertically, and the side bush is provided to be connected to at least two horizontal plates.

The side bush may be provided being connected to and penetrating at least two horizontal plates including the topmost horizontal plate among the plurality of horizontal plates of the horizontal extension portion.

The side bush may include an upper unit provided penetrating the topmost horizontal plate among the plurality of horizontal plates of the horizontal extension portion and a lower unit coupled to the upper unit while penetrating the horizontal plate other than the topmost horizontal plate.

The side bush may be shaped like a cone of which an outer diameter decreases downwards from a top flange and may include a plurality of comb-pattern protrusions formed on an outer circumferential surface thereof and forcibly press-fitted to the horizontal plates of the horizontal extension portion.

The top flange may be provided on a top of the side bush, and a lower portion of the side bush having a cylindrical shape may be forcibly transformed to enlarge an inner diameter thereof in a state of being coupled to the horizontal plate of the side member so that the side bush can be integrated into the horizontal plate of the side member.

According to embodiments of the disclosure, when a battery pack is mounted to a lower side of a vehicle body, the battery pack supported on the vehicle body is structured to more effectively distribute and support an external impact applied to a vehicle, thereby improving the crash performance of the vehicle body and the battery pack.

Further, according to embodiments of the disclosure, it is possible to accommodate as many battery cells as possible, thereby increasing the range of the vehicle and ensuring that the vehicle is sufficiently safe from a crash.

### BRIEF DESCRIPTION OF THE DRAWINGS

FIG. 1 is a view depicting a battery pack to which a battery pack mounting structure for a vehicle is applied according to embodiments of the disclosure.

FIG. 2 is a view depicting the battery pack of FIG. 1 from which an upper cover is removed.

FIG. 3 is a view depicting the battery pack of FIG. 2 from which a battery module is removed.

FIG. 4 is a perspective view of the battery pack taken along line IV-IV of FIG. 3.

FIG. 5 is a cross-sectional view illustrating that the battery pack of FIG. 4 is mounted to a vehicle body.

FIG. 6 is a view depicting a side bush of FIG. 4 in detail.

FIG. 7 is a view depicting a stopper groove formed in a side member so as to insert a stopper protrusion provided in an upper unit of FIG. 6 therein.

FIG. 8 is a view showing an example of an upper unit and a lower unit according to embodiments of the disclosure with a male threaded portion and a female threaded portion which are press-fitted to each other.

FIG. 9 is a view depicting a side bush according to another embodiment of the disclosure.

FIG. 10 is a cross-sectional view illustrating that the side bush of FIG. 9 is coupled to a side member.

FIG. 11 is a view depicting a side bush according to still another embodiment of the disclosure.

FIG. 12 is a cross-sectional view taken along line XII-XII of FIG. 1.

### DETAILED DESCRIPTION OF ILLUSTRATIVE EMBODIMENTS

Hereinafter, embodiments of the disclosure will be described in detail with reference to the accompanying drawings, in which the same or similar elements are denoted by the same reference numerals even though they are depicted in different drawings and redundant descriptions thereof will be avoided.

Suffixes “module” and “unit” put after elements in the following description are given in consideration of only ease of description and do not have meaning or functions discriminated from each other.

In terms of describing the embodiments of the disclosure, detailed descriptions of related art will be omitted when they may make the subject matter of the embodiments of the disclosure rather unclear. In addition, the accompanying drawings are provided only for a better understanding of the embodiments of the disclosure and are not intended to limit technical ideas of the disclosure. Therefore, it should be understood that the accompanying drawings include all modifications, equivalents, and substitutions within the scope and spirit of the disclosure.

Terms such as “first” and “second” may be used to describe various components, but the components should not be limited by the above terms. In addition, the above terms are used only for the purpose of distinguishing one component from another.

When it is described that one component is “connected” or “joined” to another component, it should be understood that the one component may be directly connected or joined to another component, but additional components may be present therebetween. However, when one component is described as being “directly connected” or “directly coupled” to another component, it should be understood that additional components may be absent between the one component and another component.

Unless the context clearly dictates otherwise, singular forms include plural forms as well.

In the disclosure, it should be understood that the term “include” or “have” indicates that a feature, a number, a step, an operation, an element, a part, or the combination thereof described in the embodiments is present, but does not preclude a possibility of presence or addition of one or more other features, numbers, steps, operations, elements, parts, or combinations thereof, in advance.

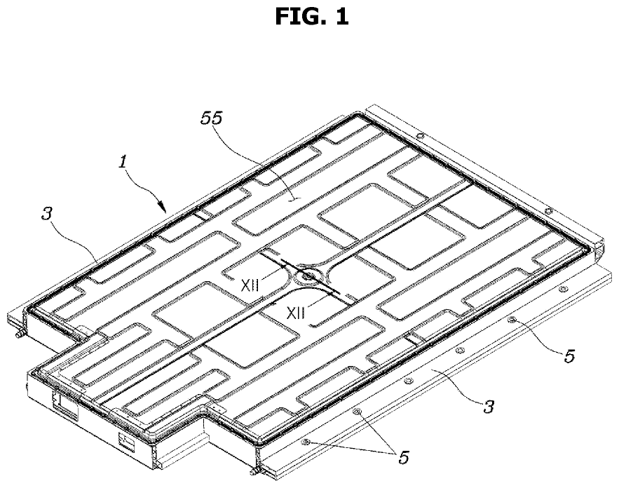

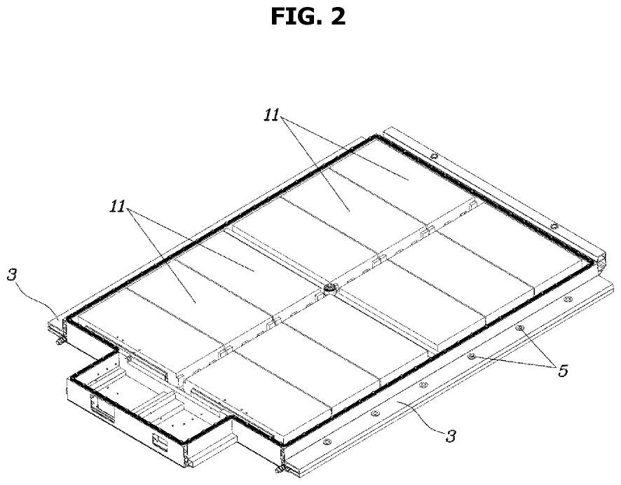

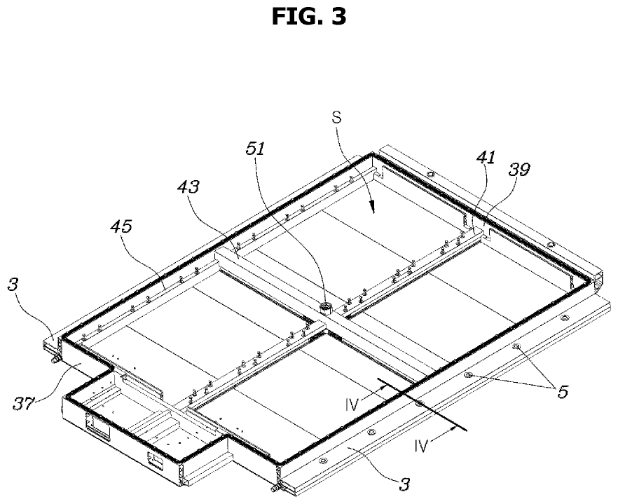

Referring to FIGS. 1 to 12, a battery pack mounting structure for a vehicle according to embodiments of the disclosure includes a side member 3 provided at a lateral side of a battery pack 1, a side bush 5 fastened passing through the side member 3 vertically, and a side mounting bolt 7 fastened to a vehicle body while passing through the side bush 5.

The side member 3 includes a plurality of partition walls 9 through which the side mounting bolt 7 passes, and the side bush 5 is fastened passing through the plurality of partition walls 9.

In other words, the side bush 5 is fastened passing through the plurality of partition walls 9 of the side member 3, so that the side bush 5 can distribute and support an impact through the plurality of partition walls 9 when the impact applied from the outside to the lateral side of the battery pack 1 is transmitted through the side mounting bolt 7.

Therefore, with regard to the impact applied to the lateral side of the vehicle as described above, a load is prevented from being locally concentrated, the relative deformation of the side member 3 is reduced by distributively supporting the load, and a battery module 11 inside the battery pack 1 is protected more effectively.

In the embodiments shown in FIGS. 1 to 7, the side bush 5 has a structure in which an upper unit 13 fastened from above the side member 3 and a lower unit 15 fastened from below the side member 3 are coupled to each other, thereby being coupled to the side member 3.

Here, the upper unit 13 and the lower unit 15 are forcibly fitted to each other to be formed as a single body.

For example, relatively to each other, the upper unit 13 and the lower unit 15 include a plurality of ribs 17 formed locally protruding from a circumferential surface thereof, and a retainer 19 formed to keep the plurality of ribs 17 transformed and inserted therein. When the upper unit 13 and the lower unit 15 are pressed against each other with the plurality of partition walls 9 of the side member 3 therebetween to transform and insert the plurality of ribs 17 in the retainer 19, the upper unit 13 and the lower unit 15 are firmly secured to the side member 3 as coupled to each other.

At least one of the upper unit 13 and the lower unit 15 may be provided integrally with a stopper protrusion 21 that restricts rotation relative to the side member 3, and the side member 3 may be formed integrally with a stopper groove 23 that allows the stopper protrusion 21 to be inserted therein and prevents the side bush 5 from the relative rotation.

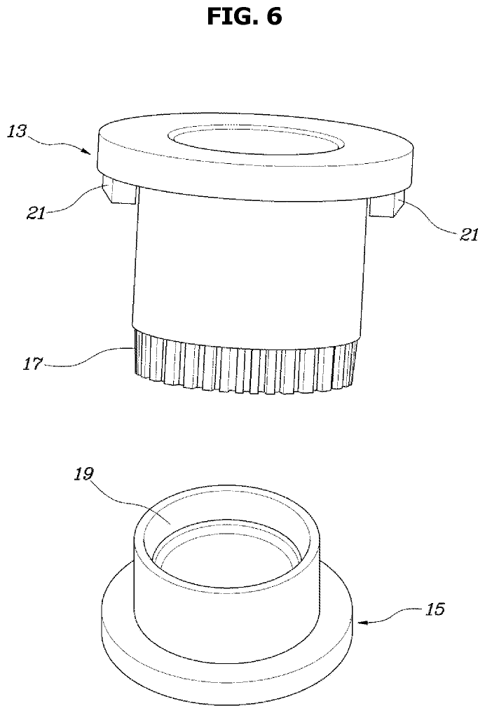

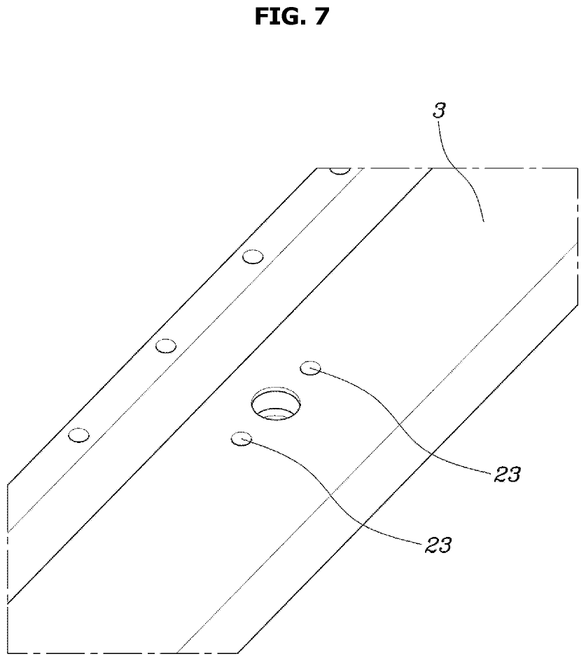

In other words, as shown in FIGS. 6 and 7, the upper unit 13 is formed with the stopper protrusion 21, and the lower unit 15 is press-fitted to the upper unit 13 in the state that the upper unit 13 is coupled to the side member 3. Then, the side bush 5 is prevented from being unnecessarily rotated when the side mounting bolt 7 is fastened to a vehicle body 25 by penetrating into the side bush 5, thereby making it easier to secure a firmer and more stable fastening state.

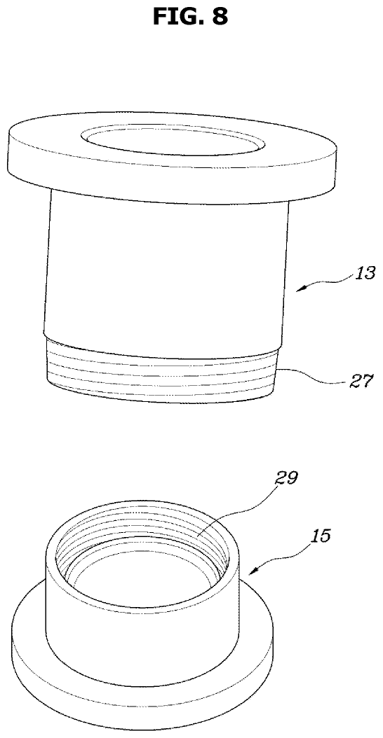

The plurality of ribs 17 may be changed to have another structure. For example, as shown in FIG. 8, relatively to each other, the upper unit 13 and the lower unit 15 may include a male threaded portion 27 formed locally protruding from a circumferential surface thereof and a female threaded portion 29 formed to keep the male threaded portion 27 transformed and inserted therein.

In this case, when the upper unit 13 and the lower unit 15 are rotated and pressed against each other with the plurality of partition walls 9 of the side member 3 therebetween, and the male threaded portion 27 and the female threaded portion 29 are transformed and coupled to each other, thereby achieving the firm coupling state between the side member 3 and the side bush 5.

Of course, in this case, the male threaded portion 27 and the female threaded portion 29 are forcibly screw-coupled unlike a general screw-coupling structure. To this end, the male threaded portion 27 is formed to have a larger diameter than that of a general structure relative to the female threaded portion 29, and the female threaded portion 29 is formed to have a smaller diameter than that a general structure relative to the male threaded portion 27.

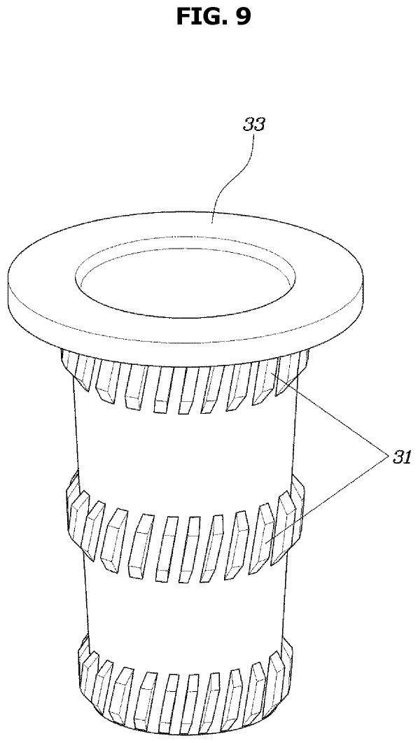

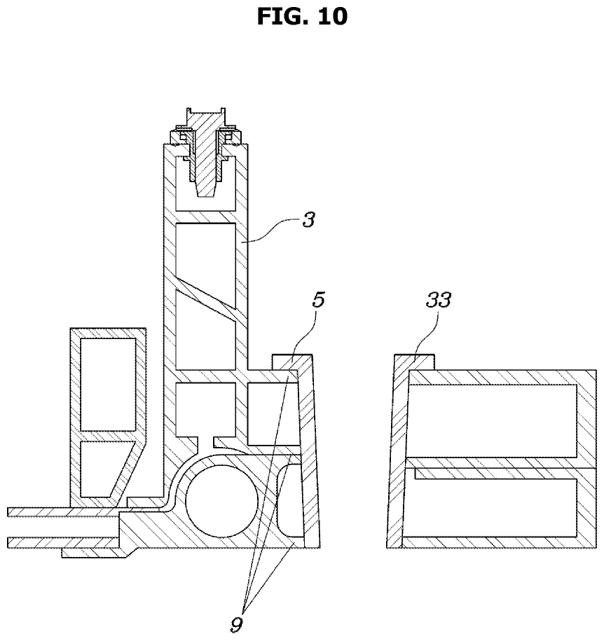

Meanwhile, referring to FIGS. 9 and 10, the side bush 5 is formed with a plurality of comb-pattern protrusions 31 on the outer circumferential surface thereof so as to be forcibly fitted into the side member 3.

Here, the side bush 5 is shaped like a cone of which the outer diameter decreases downwards from a top flange 33 and includes the comb-pattern protrusions 31 formed on the outer circumferential surface thereof and press-fitted to all the plurality of partition walls 9 of the side member 3.

Therefore, an impact load transferred from the outside through the side mounting bolt 7 is easily distributed to the plurality of partition walls 9 of the side member 3 by the side bush 5.

Of course, the comb-pattern protrusions 31 formed on the outer circumferential surface of the side bush 5 as described above are directly press-fitted to the partition wall 9 of the side member 3, and it is thus very easy and simple to couple and secure the side bush 5 to the side member 3, thereby having an effect on naturally preventing the side bush 5 from being rotated relative to the side member 3.

Further, such coupling between the side bush 5 and the side member 3 causes a substantial contact area between the side bush 5 and the partition wall 9 of the side member 3 to be secured to be much larger than that of a conventional simple coupling based on welding or the like because the comb-pattern protrusions 31 formed on the outer circumferential surface of the side bush 5 is transformed and coupled to the partition walls 9 of the side member 3, thereby more effectively distributing an external load applied to the side bush 5 to the partition walls 9 of the side member 3.

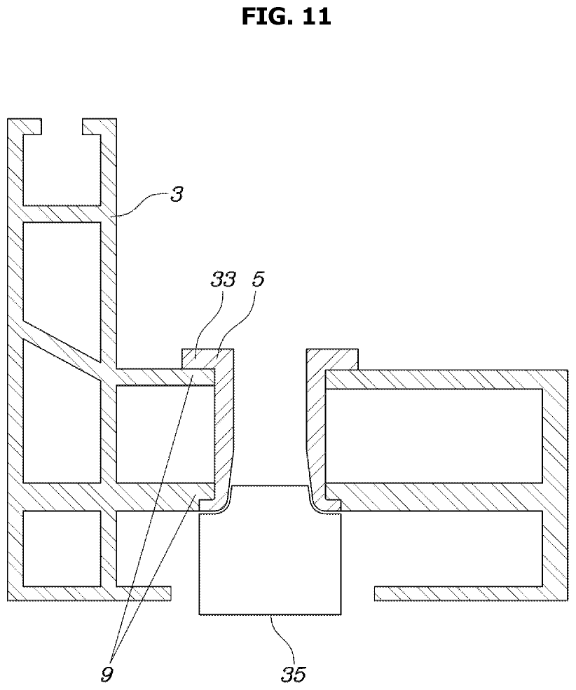

Meanwhile, according to an embodiment shown in FIG. 11, the top flange 33 is provided on the top of the side bush 5, and a lower portion of the side bush 5 having a cylindrical shape is forcibly transformed to enlarge the inner diameter thereof in the state of being coupled to the side member 3, thereby integrating the side bush 5 into the partition wall 9 of the side member 3.

In other words, the bottom of the side bush 5 undergoes plastic transformation by a tool 35 as shown in FIG. 11 to be forcibly integrated into the partition wall 9 of the side member 3, thereby achieving the firm coupling state between the side bush 5 and the side member 3.

Meanwhile, according to embodiments of the disclosure, the plurality of partition walls 9 of the side member 3 are formed in parallel with each other, and the side bush 5 is coupled penetrating the plurality of partition walls 9 perpendicularly.

Therefore, the impact transferred from the outside through the side bush 5 is more effectively distributed and supported structurally by the partition walls 9 of the side member 3.

The side members 3, together with a frontward wall 37 and a rearward wall 39, form an accommodating space S to accommodate the plurality of battery modules 11, a longitudinal member 41 crosses the accommodating space S and has both ends supported on the frontward wall 37 and the rearward wall 39, and a transverse member 43 intersects the longitudinal member 41 and has both ends supported on the opposite side members 3.

According to embodiments of the disclosure, the accommodating space S is provided with only one longitudinal member 41 and only one transverse member 43 to accommodate as many battery modules 11 as possible, thereby ultimately increasing the range of the vehicle.

The side member 3 is provided with a module mounting bar 45 on an inner side thereof, and the battery module 11 accommodated in the accommodating space S has a structure in which one of two sides perpendicular to an overlapping direction of battery cells is fastened to the module mounting bar 45 and the other is fastened to the longitudinal member 41.

For reference, the overlapping direction of the battery cells of the battery module 11 corresponds to the anteroposterior direction of the battery pack 1, and the battery cells of the battery module 11 are arranged to have surface pressure formed by the transverse member 43, the frontward wall 37, and the rearward wall 39.

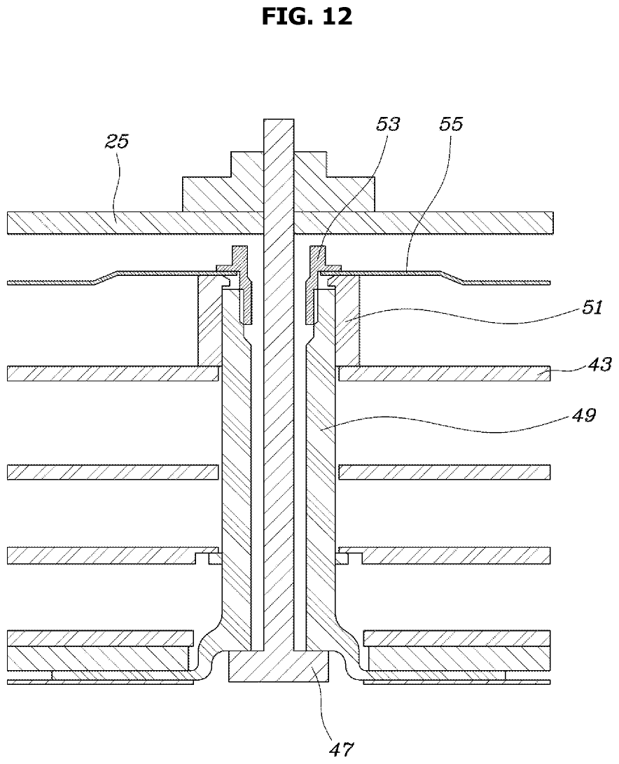

Meanwhile, a center mounting bolt 47 for securing the battery pack 1 to the vehicle body 25 by penetrating the battery pack 1 vertically is fastened at an intersection between the longitudinal member 41 and the transverse member 43 as shown in FIG. 12.

In other words, the side of the battery pack 1 is secured to the vehicle body 25 by the side mounting bolt 7, and the center of the battery pack 1 is secured to the vehicle body 25 by the center mounting bolt 47, thereby achieving a firm coupling state between the battery pack 1 and the vehicle body 25.

At the intersection between the longitudinal member 41 and the transverse member 43, a through mounting bush 49 is provided penetrating the battery pack 1 from the lower side of the battery pack 1 to the upper side of the transverse member 43 in order to form a space through which the center mounting bolt 47 passes, a securing mounting bush 51 is inserted in the upper side of the transverse member 43 to surround the outer side of the through mounting bush 49, and a bush bolt 53 is coupled to the top of the through mounting bush 49 while forming a space for the center mounting bolt 47 to pass therethrough and having a top for pressing the securing mounting bush 51 against the transverse member 43.

For reference, the reference numeral of ‘55’ in FIG. 12 refers to an upper cover of the battery pack 1.

Meanwhile, the embodiments as described above may also be expressed as follows.

In other words, the battery pack mounting structure for the vehicle according to embodiments of the disclosure includes the side member 3 having a horizontal extension portion protruding in a lateral direction and the side bush 5 fastened penetrating the horizontal extension portion of the side member 3 vertically.

The horizontal extension portion of the side member 3 includes a plurality of horizontal plates spaced apart from each other vertically, and the side bush 5 is provided to be connected to at least two horizontal plates.

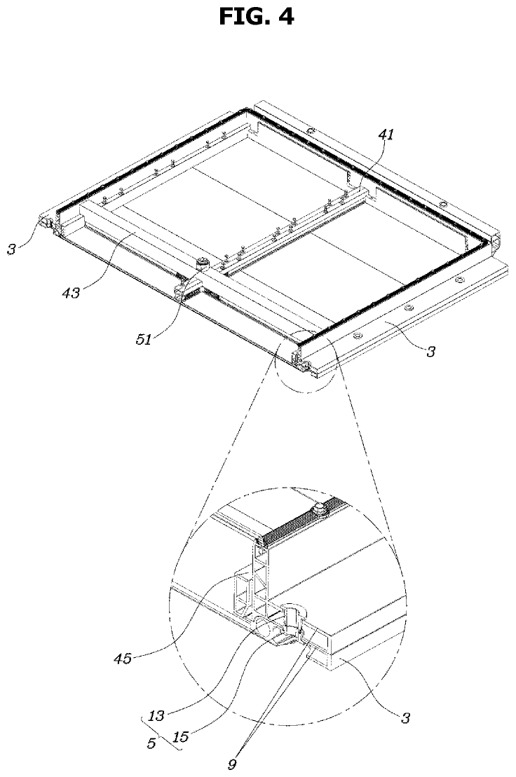

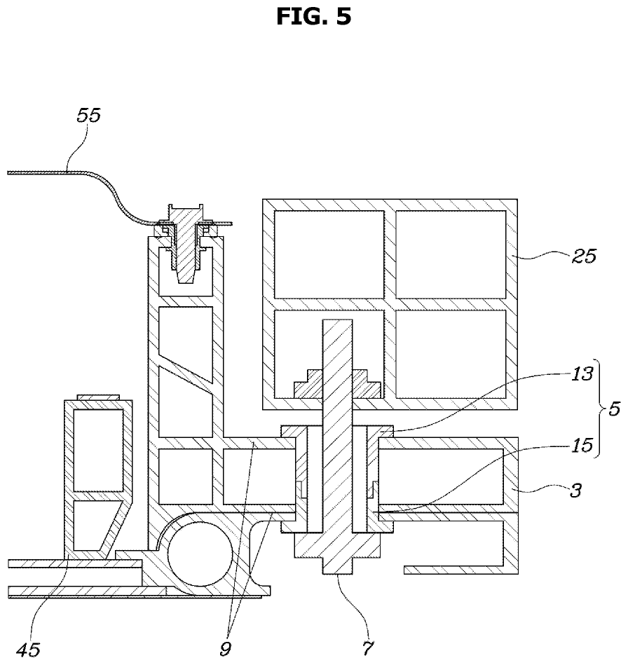

Here, it will be understood that the horizontal plates are analogous to the partition walls 9 shown in FIGS. 4 and 5.

The side bush 5 is provided being connected to and penetrating at least two horizontal plates including the topmost horizontal plate among the plurality of horizontal plates of the horizontal extension portion.

As shown in FIGS. 4 to 8, the side bush 5 may include the upper unit 13 provided penetrating the topmost horizontal plate among the plurality of horizontal plates of the horizontal extension portion and the lower unit 15 coupled to the upper unit 13 while penetrating the horizontal plate other than the topmost horizontal plate.

Further, as shown in FIGS. 9 and 10, the side bush 5 may be shaped like a cone of which the outer diameter decreases downwards from the top flange 33 and may include the comb-pattern protrusions 31 formed on the outer circumferential surface thereof and forcibly press-fitted to the horizontal plates of the horizontal extension portion.

In addition, as shown in FIG. 11, the side bush 5 includes the top flange 33 on the top thereof and the cylindrical lower portion forcibly transformed to enlarge the inner diameter thereof in the state of being coupled to the horizontal plate of the side member 3, thereby being integrated into the horizontal plates of the side member 3.

Although specific embodiments of the disclosure have been illustrated and described as above, various modifications and changes can be made by a person having ordinary knowledge in the art without departing from the scope of technical ideas defined by the appended claims.

What is claimed is:

1. A battery pack mounting structure for a vehicle, the structure comprising:
a side member disposed at a lateral side of a battery pack, the side member comprising a plurality of partition walls;
a side bush fastened passing through the side member vertically and passing through the plurality of partition walls; and
a side mounting bolt fastened to a vehicle body while passing through the side bush and the plurality of partition walls.

2. The structure of claim 1, wherein the side bush is coupled to the side member as an upper unit fastened from above the side member and a lower unit fastened from below the side member are coupled to each other.

3. The structure of claim 2, wherein the upper unit and the lower unit are forcibly fitted to each other to be a single body.

4. The structure of claim 3, wherein, relatively to each other, the upper unit and the lower unit comprise a plurality of ribs disposed locally protruding from a circumferential surface thereof and a retainer disposed to keep the plurality of ribs transformed and inserted therein.

5. The structure of claim 3, wherein, relatively to each other, the upper unit and the lower unit comprise a male threaded portion disposed locally protruding from a circumferential surface thereof and a female threaded portion disposed to keep the male threaded portion transformed and inserted therein.

6. The structure of claim 2, wherein:
the upper unit or the lower unit is provided integrally with a stopper protrusion that is configured to restrict rotation relative to the side member; and
the side member comprises a stopper groove that is integral thereto, wherein the stopper groove is configured to allow the stopper protrusion to be inserted therein and prevent the side bush from the rotation relative to the side member.

7. The structure of claim 1, wherein the side bush comprises a plurality of comb-pattern protrusions on an outer circumferential surface thereof so as to be forcibly fitted into the side member.

8. The structure of claim 7, wherein:
the side bush is shaped like a cone of which an outer diameter decreases downwards from a top flange; and
the comb-pattern protrusions on the outer circumferential surface of the side bush are press-fitted to all the plurality of partition walls of the side member.

9. The structure of claim 8, wherein:
the top flange is disposed on a top of the side bush; and
a lower portion of the side bush having a cylindrical shape is forcibly transformed to enlarge an inner diameter thereof in a state of being coupled to the side member so that the side bush can be integrated into the partition walls of the side member.

10. The structure of claim 1, wherein:
the plurality of partition walls of the side member are disposed in parallel with each other; and
the side bush is coupled penetrating the plurality of partition walls perpendicularly.

11. A battery pack mounting structure for a vehicle, the structure comprising:
a pair of side members respectively disposed at lateral sides of a battery pack, each of the side members comprising a plurality of partition walls;
a frontward wall and a rearward wall disposed on a front and a rear side of the battery pack, respectively, wherein the side members together with the frontward wall and the rearward wall define an accommodating space to accommodate a plurality of battery modules;
a longitudinal member crossing the accommodating space and having both ends supported on the frontward wall and the rearward wall, respectively;
a transverse member intersecting the longitudinal member and having both ends supported on the side members, respectively;
side bushes fastened passing through the side members vertically and passing through the plurality of partition walls; and
side mounting bolts fastened to a vehicle body while passing through the side bushes and the plurality of partition walls.

12. The structure of claim 11, wherein only one longitudinal member and only one transverse member are disposed in the accommodating space.

13. The structure of claim 11, wherein:
each of the side members comprises a module mounting bar on an inner side thereof; and
each of the battery modules accommodated in the accommodating space has a structure in which a first side of two sides perpendicular to an overlapping direction of battery cells is fastened to the module mounting bars and a second side of the two sides is fastened to the longitudinal member.

14. The structure of claim 11, wherein a center mounting bolt for securing the battery pack to the vehicle body by penetrating the battery pack vertically is fastened at an intersection between the longitudinal member and the transverse member.

15. The structure of claim 14, wherein:
at the intersection between the longitudinal member and the transverse member, a through mounting bush is disposed penetrating the battery pack from a lower side of the battery pack to an upper side of the transverse member in order to define a first space through which the center mounting bolt passes;
a securing mounting bush is inserted in the upper side of the transverse member to surround an outer side of the through mounting bush; and
a bush bolt is coupled to a top of the through mounting bush while defining a second space for the center mounting bolt to pass therethrough and comprising a top configured to press the securing mounting bush against the transverse member.

16. A battery pack mounting structure for a vehicle, the structure comprising:
a side member comprising a horizontal extension portion protruding in a lateral direction, wherein the horizontal extension portion of the side member comprises a plurality of horizontal plates spaced apart from each other vertically; and
a side bush fastened penetrating the horizontal extension portion of the side member vertically, wherein the side bush is configured to be connected to at least two horizontal plates of the plurality of horizontal plates.

17. The structure of claim 16, wherein the side bush is configured to be connected to and penetrate the at least two horizontal plates comprising a topmost horizontal plate among the plurality of horizontal plates of the horizontal extension portion.

18. The structure of claim 16, wherein the side bush comprises:
an upper unit disposed penetrating a topmost horizontal plate among the plurality of horizontal plates of the horizontal extension portion; and
a lower unit coupled to the upper unit while penetrating a horizontal plate of the plurality of horizontal plates other than the topmost horizontal plate.

19. The structure of claim 16, wherein:
the side bush is shaped like a cone of which an outer diameter decreases downwards from a top flange; and
the side bush comprises a plurality of comb-pattern protrusions disposed on an outer circumferential surface thereof and forcibly press-fitted to the horizontal plates of the horizontal extension portion.

20. The structure of claim 19, wherein:
the top flange is disposed on a top of the side bush; and
a lower portion of the side bush having a cylindrical shape is forcibly transformed to enlarge an inner diameter thereof in a state of being coupled to the horizontal plates of the horizontal extension portion so that the side bush can be integrated into the horizontal plates of the horizontal extension portion.
